(19) United States
(12) Patent Application Publication
(10) Pub. No.: US 2021/0158277 A1
(43) Pub. Date: May 27, 2021

(54) TRANSFORMATION OF DEMANDS IN A SUPPLY CHAIN NETWORK

(71) Applicant: Kinaxis Inc., Ottawa (CA)

(72) Inventors: Prabhakar Regmi, Ottawa (CA); Rob MacMillan, Ottawa (CA)

(21) Appl. No.: 16/697,009

(22) Filed: Nov. 26, 2019

(51) Int. Cl. G06Q 10/08; G06Q 10/06

(52) U.S. Cl. CPC G06Q 10/087; G06Q 10/06312; G06Q 10/06315

(57) ABSTRACT

Systems and methods in which a demand planning schedule and a safety stock schedule of an entity in a supply chain are managed, by creating a transformed demand planning schedule, which is obtained by allocating one or more safety stock demands to one or more non-safety stock demands and creating one or more new safety stock demands to maintain the safety stock schedule.

### TECHNICAL FIELD

This disclosure relates to the field of supply chains. In particular, it relates to management of demands in a supply chain network.

### BACKGROUND

This disclosure relates generally to the field of supply chain management and more specifically to optimization of inventory demand.

Within a supply chain, products are supplied to customers in response to demand. Within the supply chain, there are entities that supply a product, components of a product, or resources needed to produce products. The supply chain also includes entities that solely receive a product. There may also be entities that receive a product, components of a product, or resources needed to produce products; and supply a product, components of a product, or resources needed to produce products to entities further down the supply chain. Each entity within the chain has a demand schedule and a safety stock schedule, to plan for orders of inventory. Both the demand schedule and the safety stock schedule are used to make planning orders for inventory to an entity within the supply chain. Often times, the safety stock of an entity may be used to fulfill an impending demand. This often leads to purchase orders that miss actual demands, and thus lead to negative consequences of supply that propagate through the supply chain.

U.S. Pat. No. 10,311,391 (issued Jun. 4, 2019) discloses a method to optimize inventory in accordance with a constrained network. In this method, service level band sets are accessed. A feasible supply chain plan that satisfies the inventory band sets is generated in order of the inventory priorities until a constrained network is depleted.

US 20130138470 discloses a system and method for supply chain optimization which comprises identifying a supply chain optimization scheme enabled by an enterprise resource planning implementation on the basis of one or more system limitations. One or more process flows and requirements associated with the supply chain are compared with pre-developed process flows and requirements. A key performance indicator framework comprising one or more performance metrics by which the time and cost efficiency of a supply chain is measured, is provided.

### BRIEF SUMMARY

In an aspect, a system comprising: one or more processors; and a memory storing instructions that, when executed by the one or more processors, configure the system to: access, by a supply chain planning engine, a demand planning schedule and a safety stock schedule of a supply chain entity; process, by the one or more processors, a demand of the demand planning schedule chronologically, process, by the one or more processors, two or more demands according to level of priority from highest priority to lowest priority when the two or more demands have an identical date; and create, by an optimization engine, a transformed demand planning schedule by allocating one or more safety stock demands to one or more non-safety stock demands and creating one or more new safety stock demands to maintain the safety stock schedule.

In some embodiments, if the demand is a safety stock demand, creating the transformed demand planning schedule may comprise: adding, by the optimization engine, the demand to a safety stock demand list; and process, by the one or more processors, a next demand of the demand planning schedule if the demand is not a last demand. In some embodiments, if the demand is a real demand and the safety stock list is empty and the real demand is not the last demand, creating the transformed demand planning schedule may comprise processing, by the one or more processors, the next demand. In some embodiments, if the demand is a real demand and the safety stock list is not empty, creating the transformed demand planning schedule may comprise: transforming, by the optimization engine, the real demand into a transformed demand using an earliest safety stock demand in the safety stock demand list; updating, by the optimization engine, a demand date of the transformed demand and a demand priority of the transformed demand; updating, by the optimization engine, the safety stock demand list based on the transformed demand; and updating, by the optimization engine, the safety stock demand list based on a current safety stock level.

In some embodiments, the system can be further configured to: determine, by the optimization engine, a demand type of the demand; if the demand type is a safety stock: add, by the optimization engine, a safety stock date and a safety stock quantity to a safety stock demand list; and if the demand type is a non-safety stock, transform the non-safety stock demand to an earliest demand in the safety stock demand list and update the safety stock list to include a safety stock demand that maintains a safety stock quantity on the date of the demand.

In some embodiments, where a non-safety stock demand quantity is less than or equal to a safety stock quantity of the earliest demand, the system can be further configured to: i) move, by the optimization engine, the non-safety stock demand to an earliest demand date in the safety stock demand list; and ii) subtract, by the optimization engine, the non-safety demand quantity from the safety stock quantity of the earliest demand in the safety stock demand list, to provide an updated safety stock quantity of the earliest demand.

In some embodiments, the system can be further configured to: compare, by the optimization engine, the safety stock demand quantity in the safety stock demand list to the safety stock quantity; and add, by the optimization engine, a new safety stock demand if the safety stock quantity is greater than the safety stock demand quantity.

In another aspect, a method comprising: accessing, by a supply chain planning engine, a demand planning schedule and a safety stock schedule of a supply chain entity; processing, by one or more processors of a server, each demand of the demand planning schedule chronologically, processing, by the one or more processors, the demands according to level of priority from highest priority to lowest priority when two or more demands occur have an identical date; and creating, by an optimization engine, a transformed demand planning schedule by allocating one or more safety stock demands to one or more non-safety stock demands and creating one or more new safety stock demands to maintain the safety stock schedule.

In some embodiments, if the demand is a safety stock demand, creating the transformed demand planning schedule, may comprise adding, by the optimization engine, the demand to a safety stock demand list; and processing, by the one or more processors, a next demand of the demand planning schedule.

In some embodiments, if the demand is a real demand, creating the transformed demand planning schedule, may comprise: processing, by the one or more processors, the next demand if the safety stock demand list is empty; transforming, by the optimization engine, the real demand into a transformed demand using an earliest safety stock demand in the safety stock demand list; updating, by the optimization engine, a demand date of the transformed demand and a demand priority of the transformed demand; updating, by the optimization engine, the safety stock demand list based on the transformed demand; and updating, by the optimization engine, the safety stock demand list based on a current safety stock level.

In some embodiments, the method may further comprise: determining, by the optimization engine, a demand type of the demand; and if the demand type is a safety stock demand, adding, by the optimization engine, a date and a quantity of the safety stock demand to a safety stock demand list.

In some embodiments, the method may further comprise: determining, by the optimization engine, a demand type of the demand; and if the demand type is a non-safety stock: transforming, by the optimization engine, the non-safety stock demand to an earliest demand in the safety stock demand list and updating the safety stock list to include a safety stock demand that maintains a safety stock quantity on the date of the demand.

In some embodiments, where the non-safety stock demand quantity is less than or equal to a safety stock quantity of the earliest demand, the method may further comprise: i) moving, by the optimization engine, the non-safety stock demand to an earliest demand date in the safety stock demand list; and ii) subtracting, by the optimization engine, the non-safety demand quantity from the safety stock quantity of the earliest demand in the safety stock demand list, to provide an updated safety stock quantity of the earliest demand.

In some embodiments, the method may further comprise: comparing, by the optimization engine, the safety stock demand quantity in the safety stock demand list to the safety stock quantity; and adding, by the optimization engine, a new safety stock demand if the safety stock quantity is greater than the safety stock demand quantity.

In another aspect, a non-transitory computer-readable medium embodied with software, the software when executed using one or more processors on a server, is configured to: access a demand planning schedule and a safety stock schedule associated with a supply chain entity stored in a database coupled to the server; process each demand of the demand planning schedule chronologically to create a transformed demand planning schedule, by allocating one or more safety stock demands to one or more non-safety stock demands and creating one or more new safety stock demands to maintain the safety stock schedule; and where two or more demands have an identical date, process the two or more demands according to level of priority from highest priority to lowest priority.

In some embodiments, if the demand is a safety stock demand, creating the transformed demand planning schedule may comprise adding, by the optimization engine, the demand to a safety stock demand list; and processing, by the one or more processors, a next demand of the demand planning schedule.

In some embodiments, if the demand is a real demand, creating the transformed demand planning schedule may comprise: processing, by the one or more processors, the next demand if the safety stock demand list is empty; transforming, by the optimization engine, the real demand into a transformed demand using an earliest safety stock demand in the safety stock demand list; updating, by the optimization engine, a demand date of the transformed demand and a demand priority of the transformed demand; updating, by the optimization engine, the safety stock demand list based on the transformed demand; and updating, by the optimization engine, the safety stock demand list based on a current safety stock level.

In some embodiments, the computer may be further configured to: determine, by the optimization engine, a demand type of the demand; if the demand type is a safety stock demand: add, by the optimization engine, a date and a quantity of the safety stock demand to a safety stock demand list; and if the demand type is a non-safety stock, transform the non-safety stock demand to an earliest demand in the safety stock demand list and update the safety stock list to include a safety stock demand that maintains a safety stock quantity on the date of the demand.

In some embodiments, where the non-safety stock demand quantity is less than or equal to a safety stock quantity of an earliest demand, the computer may be further configured to: i) move, by the optimization engine, the non-safety stock demand to an earliest demand date in the safety stock demand list; and ii) subtract, by the optimization engine, the non-safety demand quantity from the safety stock quantity of the earliest demand in the safety stock demand list, to provide an updated safety stock quantity of the earliest demand.

In some embodiments, the computer may be further configured to: compare, by the optimization engine, the safety stock demand quantity in the safety stock demand list to the safety stock quantity; and add, by the optimization engine, a new safety stock demand if the safety stock quantity is greater than the safety stock demand quantity.

In another aspect, a system comprising: a database that stores information about a demand planning schedule and safety stock schedule of a supply chain entity; the demand planning schedule comprising a plurality of demands, each demand having a date, a type, a priority and a quantity; and the safety stock schedule comprising one or more safety stock quantities, each safety stock quantity having a date range; a server comprising one or more processors, the server coupled to the database and configured to: access the demand planning schedule and safety stock schedule stored in the database; process each demand of the demand planning schedule chronologically to create a transformed demand planning schedule, by allocating one or more safety stock demands to one or more non-safety stock demands and creating one or more new safety stock demands to maintain the safety stock schedule; and where two or more demands occur on the same date, process the demands according to level of priority from highest priority to lowest priority. In some embodiments, in processing each demand, the server can be further configured to: determine the demand type; if the demand type is a safety stock, add the date and quantity of the safety stock demand to a safety stock demand list; and if the demand type is a non-safety stock, transform the non-safety stock demand to an earliest demand in the safety stock demand list and update the safety stock list to include a safety stock demand that maintains the safety stock quantity on the date of the demand. In some embodiments, in transforming the non-safety stock demand, the server can be further configured to: where the non-safety stock demand quantity is less than or equal to the safety stock quantity of the earliest demand: i) move the non-safety stock demand to the earliest demand date in the safety stock demand list; and ii) in the safety stock demand list, subtract the non-safety demand quantity from the safety stock quantity of the earliest demand to provide an updated safety stock quantity of the earliest demand. In some embodiments, in updating the safety stock demand list, the server can be further configured to: compare the safety stock demand quantity in the safety stock demand list to the safety stock quantity; and add a new safety stock demand if the safety stock quantity is greater than the safety stock demand quantity.

In another aspect, a computer-implemented method comprising: accessing a demand planning schedule and a safety stock schedule of a supply chain entity stored in a database; processing, by one or more processors of a server coupled to the database, each demand of the demand planning schedule chronologically to create a transformed demand planning schedule, by allocating one or more safety stock demands to one or more non-safety stock demands and creating one or more new safety stock demands to maintain the safety stock schedule; and where two or more demands occur on the same date, processing the demands according to level of priority from highest priority to lowest priority. In some embodiments, processing each demand chronologically may comprise: determining the demand type; if the demand type is a safety stock, adding the date and quantity of the safety stock demand to a safety stock demand list; and if the demand type is a non-safety stock, transforming the non-safety stock demand to an earliest demand in the safety stock demand list and updating the safety stock list to include a safety stock demand that maintains the safety stock quantity on the date of the demand. In some embodiments, transforming the non-safety stock demand may comprise: where the non-safety stock demand quantity is less than or equal to the safety stock quantity of the earliest demand: i) moving the non-safety stock demand to the earliest demand date in the safety stock demand list; and ii) in the safety stock demand list, subtracting the non-safety demand quantity from the safety stock quantity of the earliest demand to provide an updated safety stock quantity of the earliest demand. In some embodiments, updating the safety stock demand list may comprise: comparing the safety stock demand quantity in the safety stock demand list to the safety stock quantity; and adding a new safety stock demand if the safety stock quantity is greater than the safety stock demand quantity.

In another aspect, a non-transitory computer-readable medium embodied with software, the software when executed using one or more processors on a server, is configured to: access a demand planning schedule and a safety stock schedule associated with a supply chain entity stored in a database coupled to the server; process each demand of the demand planning schedule chronologically to create a transformed demand planning schedule, by allocating one or more safety stock demands to one or more non-safety stock demands and creating one or more new safety stock demands to maintain the safety stock schedule; and where two or more demands occur on the same date, process the demands according to level of priority from highest priority to lowest priority. In some embodiments, in processing each demand chronologically, the software can be further configured to: determine the demand type; if the demand type is a safety stock, add the date and quantity of the safety stock demand to a safety stock demand list; and if the demand type is a non-safety stock, transform the non-safety stock demand to an earliest demand in the safety stock demand list and update the safety stock list to include a safety stock demand that maintains the safety stock quantity on the date of the demand. In some embodiments, in transforming the non-safety stock demand, the software can be further configured to: where the non-safety stock demand quantity is less than or equal to the safety stock quantity of the earliest demand: i) move the non-safety stock demand to the earliest demand date in the safety stock demand list; and ii) in the safety stock demand list, subtract the non-safety demand quantity from the safety stock quantity of the earliest demand to provide an updated safety stock quantity of the earliest demand. In some embodiments, in updating the safety stock demand list, the software can be further configured to: compare the safety stock demand quantity in the safety stock demand list to the safety stock quantity; and add a new safety stock demand if the safety stock quantity is greater than the safety stock demand quantity.

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

### BRIEF DESCRIPTION OF THE DRAWINGS

To easily identify the discussion of any particular element or act, the most significant digit or digits in a reference number refer to the figure number in which that element is first introduced.

FIG. 1 illustrates a supply chain in accordance with one embodiment.

FIG. 2 illustrates an example system for optimizing inventory in accordance with an embodiment.

FIG. 3 illustrates a conventional example of a demand schedule in a supply chain.

FIG. 4 illustrates an example supply chain.

FIG. 5 illustrates an example of a conventional demand schedule in the supply chain of FIG. 4.

FIG. 6 illustrates a production result based on demand scheduling of FIG. 5

FIG. 7 illustrates a demand transformation in a supply chain in accordance with one embodiment.

FIG. 8 illustrates a flowchart for demand transformation in accordance with one embodiment.

FIG. 9 illustrates a flow chart for a demand transformation using a safety stock demand list and a safety stock level in accordance with one embodiment.

FIG. 10 illustrates demand processing of April 1 and April 10 of demands of A shown in FIG. 7.

FIG. 11 illustrates demand processing of April 15 and April 22 of demands of A shown in FIG. 7

FIG. 12 illustrates transformation of demands of entity A in accordance with the embodiment shown in FIG. 7.

FIG. 13 illustrates transformation of demands of entity B in accordance with the embodiment shown in FIG. 7.

FIG. 14 illustrates a transformation of demand schedules in accordance with one embodiment.

FIG. 15 illustrates a production result following the demand transformation illustrated in FIG. 14.

FIG. 16 illustrates a transformation of demand schedules in accordance with one embodiment.

FIG. 17 illustrates a production result following the demand transformation illustrated in FIG. 14.

### DETAILED DESCRIPTION

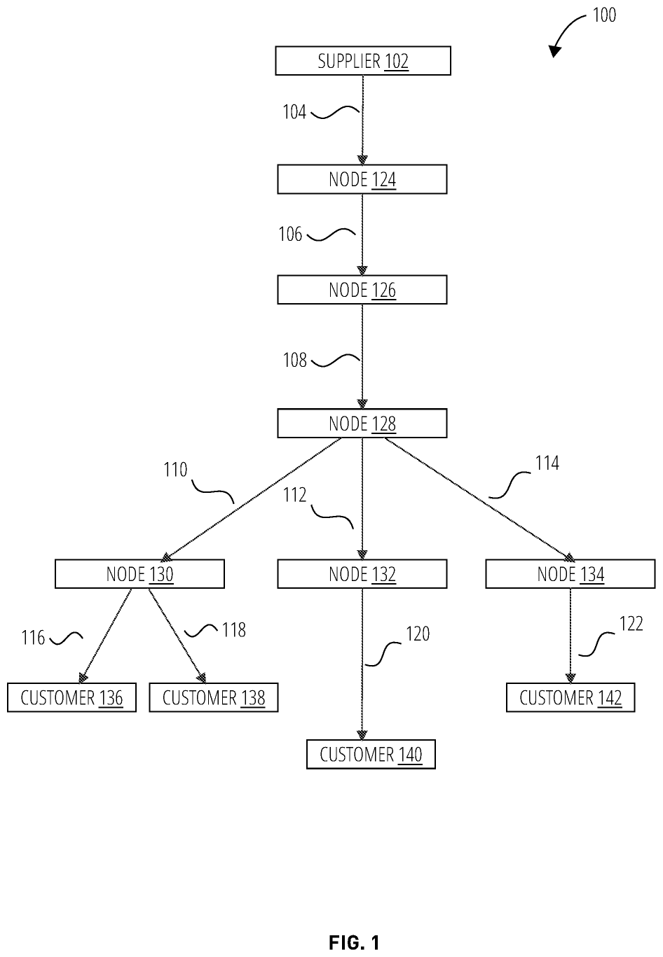

FIG. 1 is a block diagram illustrating an example supply chain 100 that receives supplies from a supplier 102 and provides products to one or more customers 136, 138, 142 and 140.

Supply chain 100 may include any number of nodes 124, 126, 128, 130, 132 and 134. In addition, supply chain 100 may include any number of links 104, 106, 108, 110, 112, 114, 116, 118, and 120 that are configured between the nodes.

In the example supply chain 100 shown in FIG. 1, supplier 102 supplies items to node 124 via link 104, which in turn supplies items to node 126 via link 106, which in turn supplies items to node 128 via link 108, which in turn supplies items to node 130 via link 110, node 132 via link 112 and node 134 via link 114. Node 130 supplies two customers: customer 136 via link 116 and customer 138 via link 118. Node 132 provides items to customer 140 via link 120. Node 134 supplies items to customer 142 via link 122. In the example provided, nodes receive and supply items.

Items in the supply chain 100 may include products, parts, components, raw material, and other entities known in the art. Inventory may be a class of item that is stored at a node in order to meet demand and/or manage supply risk. While one supplier 102 is shown in example supply chain 100, it is understood that one or more suppliers may form part of supply chain 100. Similarly, while four customers are shown in FIG. 1, it is understood that fewer, or more, customers may be present in the supply chain 100. In general, there can be any suitable modification of suppliers, customers, nodes and links in the supply chain without departing from the scope of the invention.

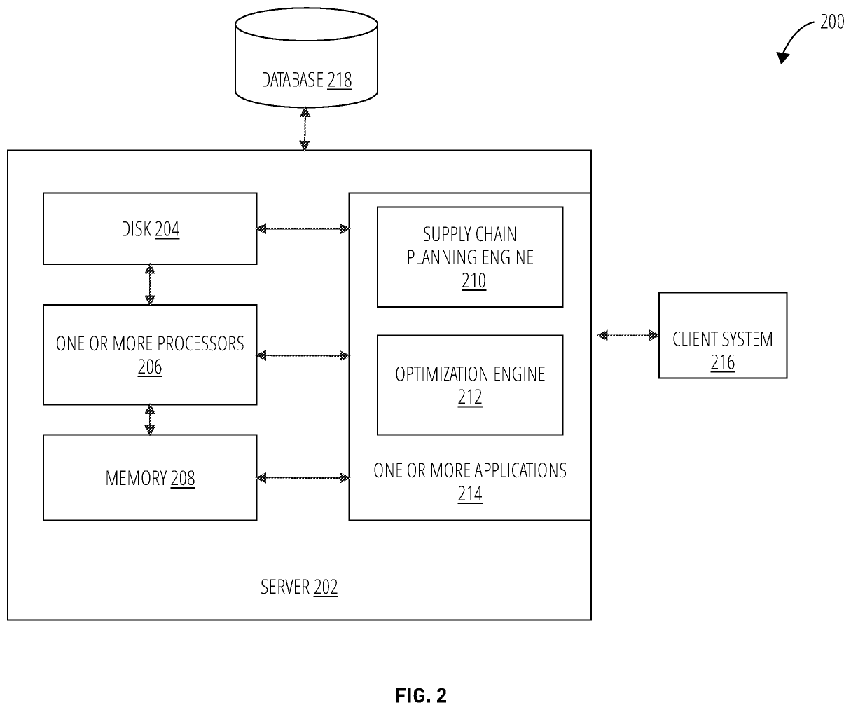

FIG. 2 illustrates an example system 200 for optimizing inventory in accordance with an embodiment.

According to the illustrated embodiment, system 200 can include a client system 216, a server 202 and a database 218 coupled as shown in FIG. 2. A user may use client system 216 in order to communicate with server 202 to optimize inventory in supply chain 100. Server 202 can manage one or more engines or other applications for optimizing inventory in supply chain 100. Database 218 includes any suitable memory, database, or other data storage arrangement that stores data that may be used by server 202.

According to the illustrated embodiment, server 202 may include disk 204, one or more processors 206, memory 208 and one or more applications 214 coupled as shown in FIG. 2. One or more processors 206 manage the operation of server 202, and may comprise any device operable to accept input, process the input according to predefined rules, and produce an output. In some embodiments, one or more processors 206 may comprise parallel processors in a distributed processing environment.

In some embodiments, memory 208 can be volatile memory, compared with disk 204 which can be non-volatile memory. While database 218 is illustrated as separate from server 202, database 218 can also be integrated into server 202, either as a separate component within server 202, or as part of at least one of memory 208 and disk 204.

System 200 can also include additional features and/or functionality. For example, system 200 can also include additional storage (removable and/or non-removable) including, but not limited to, magnetic or optical disks or tape. Such additional storage is illustrated in FIG. 2 by disk 204 and memory 208. Storage media can include volatile and nonvolatile, removable and non-removable media implemented in any method or technology for storage of information such as computer-readable instructions, data structures, program modules or other data. Disk 204 and memory 208 are examples of non-transitory computer- readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 200. Any such non-transitory computer-readable storage media can be part of system 200.

According to FIG. 2, one or more applications 214 may include an optimization engine 212 and a supply chain planning engine 210. One or more applications 214 may be configured to execute on one or one or more processors 206 in any suitable manner. In some embodiments, one or more applications 214 may execute on one or more processors 206. As another example, a primary application of the one or more applications 214 and a backup application of the one or more applications 214 may execute on a plurality of the one or more processors 206. Optimization engine 212 may optimize the inventory at nodes 124, 126, 128, etc. of supply chain 100.

Supply chain planning engine 210 generates a supply chain plan. For example, supply chain planning engine 210 can generate a supply chain plan for supply chain 100 shown in FIG. 1. In some embodiments, supply chain planning engine 210 can generate a supply chain plan that satisfies demands in order of priority. The supply chain plan may ensure that a lower priority demand is not satisfied at the expense of a higher priority demand.

Supply chain planning engine 210 can generate a supply chain plan in accordance with input. Input may include, for example, information about demand, supply, or both. Demand information may include, for example, a demand forecast, work orders, work in progress, other information, or any combination thereof. Supply information may include, for example, the amount of supply, the supply lead times, the supply risk, other information, or any combination thereof.

Client system 216 and server 202 may each operate on one or more computers and may include appropriate input devices, output devices, mass storage media, processors, memory, or other components for receiving, processing, storing, and communicating information according to the operation of system 200. As used in this document, the term “computer” refers to any suitable device operable to accept input, process the input according to predefined rules, and produce output.

Client system 216, server 202, and database 218 may be integrated or separated according to particular needs. In some embodiments, the functions of both client system 216 and server 202 are provided using a single computer system, such as a single personal computer. In some embodiments, database 218 may reside within server 202. If any combination of client system 216, server 202, or database 218 are separated, they may be coupled to each other using a local area network (LAN), a metropolitan area network (MAN), a wide area network (WAN), a global computer network such as the Internet, or any other appropriate wireline, optical, wireless, or other link. Modifications, additions, or omissions may be made to system 200 without departing from the scope of the invention. For example, fewer or other components may perform the operations of system 200. For example, the operations of optimization engine 212 and supply chain planning engine 210 may be performed by one component, or the operations of optimization engine 212 may be performed by more than one component. Additionally, functions may be performed using any suitable logic comprising software, hardware, other logic, or any suitable combination of the preceding.

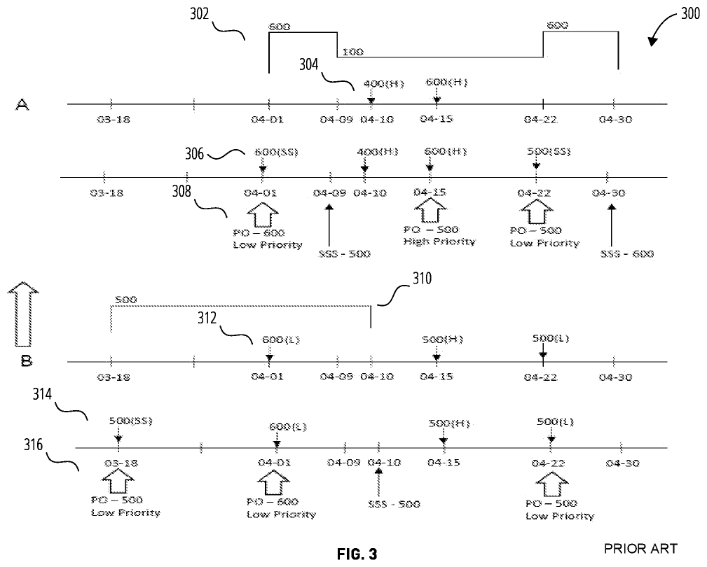

FIG. 3 illustrates a conventional example of a demand schedule in a supply chain 300, in which entity A receives supply from entity B. B supplies A with units of a product, that may include parts, merchandise, and other units of supply known in the art. Each of A and B has a set of demands—that is, a request for units. The demand may be a safety stock demand (i.e. a demand to increase units in the safety stock of the entity) or may be an external or “real” demand. When filling demands, a real demand has a higher priority than a safety stock demand, since failure to fill a real demand has greater consequences in the supply chain than failure to fill a safety stock demand. Furthermore, there can be an order of priority within real demands, from low priority (L) to medium priority (M) to high priority (H). The order of priority (from lowest to highest) of all demands is thus: safety stock (SS)<low priority (L) real demand<medium priority (M) real demand<high priority (H) real demand.

In FIG. 3, the safety stock schedule of A 302 indicates that 600 units should be in the safety stock of A between April 1 and April 9; on April 9, the safety stock drops to 100 units and is maintained at that level until April 22; on April 22, the safety stock level jumps to 600 and stays at that level until April 30; and on April 30, the safety stock level drops to 0.

The real demand schedule of A 304 indicates that there is a high priority (H) demand for 400 units scheduled for April 10 and an H demand for 600 units scheduled for April 15.

In order to fulfill both the safety stock schedule of A 302 and the real demand schedule of A 304, the result is a full demand schedule of A 306, which is described as follows. On April 1, there is a safety stock (SS) demand of 600 units in order to satisfy the safety stock requirement of 600 units on April 1 (as shown in safety stock schedule of A 302). On April 10, there is a H demand of 400 units and on April 15, there is a H demand of 600 units. On April 22, the safety stock schedule of A 302 indicates a jump of 500 units (from 100 to 600), requiring a safety stock (SS) demand of 500 units.

The planned order schedule of A 308 is derived from full demand schedule of A 306 and the safety stock schedule of A 302 as follows. On April 1, there is a stock supply (SS) of 600 units required in order to satisfy the safety stock requirement of 600 units on April 1 (as shown in safety stock schedule of A 302). This results in a low priority planned order (PO) of 600 units on April 1. On April 9, there is a drop of 500 units (from 600 to 100). This drop is seen as the safety stock supply (SSS) of A. The release of safety stock supply (SSS) allows for the availability of 500 units for future demands.

On April 10, the high priority (H) real demand of 400 units is filled by the safety stock supply (SSS) of 500 units that were made available on April 9, leaving 100 units in the safety stock supply (SSS) available for future real demands. On April 15, the High Priority demand of 600 units is partially filled by the 100 units remaining in the safety stock supply (SSS), requiring a high priority PO of 500 units. This is the last of the high priority demands on A.

On April 22, the safety stock schedule of A 302 indicates a jump of 500 units (from 100 to 600), requiring a stock supply (SS) demand of 500 units, which is filled by a low priority PO of 500 units. Therefore, the planned order schedule of A 308 requires two low priority POs (600 units on April 1 and 500 units on April 22) and one high priority PO (500 units on April 15).

The planned orders created at A spins off dependent demands on B. The priorities of the planned orders at A are inherited by the demands that are created at B. That is, B has inherited: a L demand of 600 units on April 1, a H demand of 500 units on April 15 and a L demand of 500 units on April 22. These are all demands originating from A. In addition, the safety stock schedule of B 310 indicates that there are 500 units maintained in the safety stock of B from March 18 to April 10.

The safety stock schedule of B 310 and the real demand schedule of B 312 combine to provide the full demand schedule of B 314, which is described as follows. On March 18, the safety stock of B jumps from 0 to 500, resulting in a safety stock (SS) demand of 500 units. The remaining demands are 600 low priority (L) units on April 1, 500 high priority (H) units on April 16 and 500 low priority (L) units on April 22.

The planned order schedule of B 316 is derived from the full demand schedule of B 314 and the safety stock schedule of B 310 as follows. The 500 safety stock (SS) demand on March 18 is filled by a L PO of 500 units. Similarly, the L demand of 600 units on April 1 is filled by a L PO of 600. On April 10, the safety stock supply of B drops from 500 units to 0 units, making 500 units available for future demands on B. On April 15, the HP demand of 500 units is filled by the 500 units of SSS made available on April 10. There are no more units in the SSS available for future demands. Therefore, the last LP demand of 500 units on April 22 is filled by a LP PO of 500 units. That is, the planned order schedule of B 316 requires a total of three LP POs: 500 units on March 18, 600 units on April 1 and 500 units on April 22.

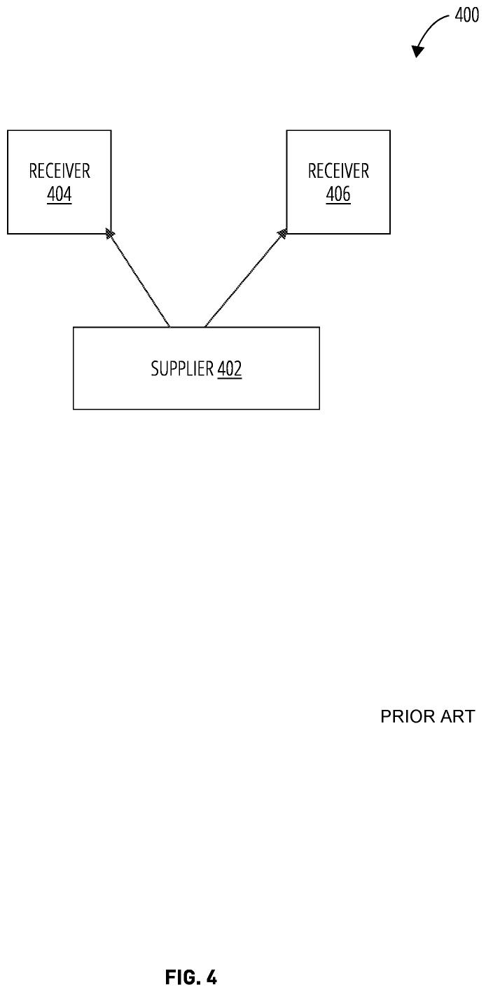

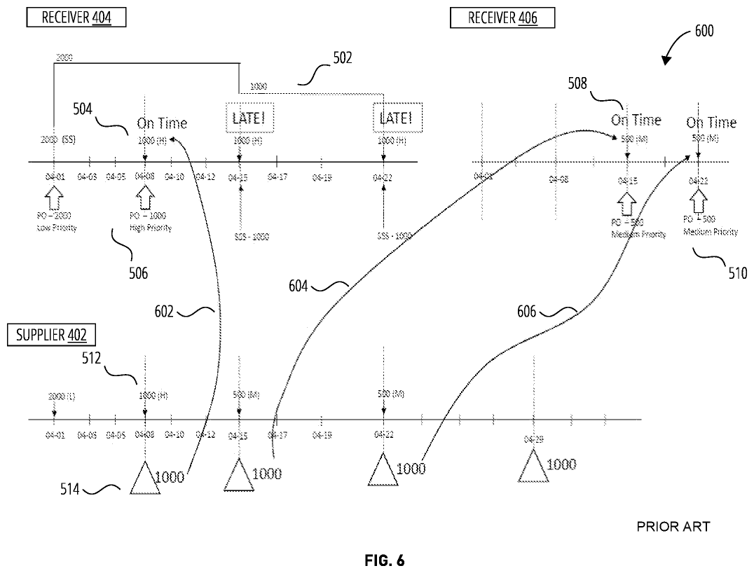

The problem with the planned order schedule of B 316 is that none of the planned orders are high priority, even if these are satisfying high priority demands on A. This has negative implications for fulfilling high priority demands in time, as illustrated in the conventional examples shown in FIG. 4 - FIG. 6.

FIG. 4 is a block diagram that illustrates an example supply chain 400. Supplier 402 provides one or more products to one or more receivers, for example receiver 404 and receiver 406. For example, supplier 402 may be a manufacturer that supplies a product to a first distribution center (receiver 404) and a second product to a second distribution center (receiver 406).

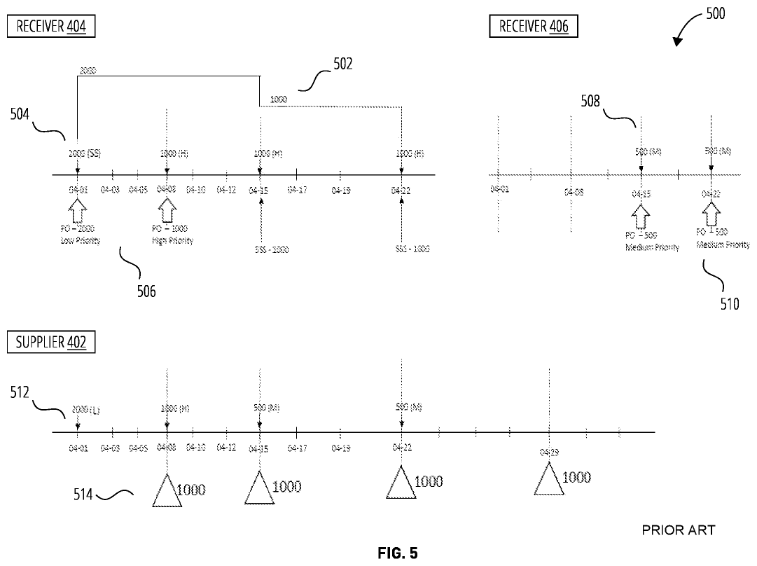

FIG. 5 illustrates an example 500 of a conventional demand schedule in the supply chain of FIG. 4. The demand schedule and planning order of each receiver 404, receiver 406 and supplier 402 is discussed below.

Receiver 404 has a safety stock schedule 502, real demand schedule 504 and planned order schedule 506.

The safety stock schedule 502 requires a safety stock level of 2,000 units from April 1 to April 15; a drop of 1,000 units to 1,000 units on April 15, which is maintained until April 22, and then a drop of 1,000 units to 0 units on April 22.

The real demand schedule 504 indicates a safety stock (SS) demand of 2,000 units on April 1, in order to fulfill the safety stock requirement of 2,000 units on April 1. Then there are three high priority (H) demands: on April 8, a H demand for 1,000 units; a H demand for 1,000 units on April 15; and a H demand for 1,000 units on April 22.

The planned order schedule 506 is then derived from the safety stock schedule 502 and the real demand schedule 504 as follows. On April 1, there is a PO of 2,000 units at low priority, in order to fulfill the safety stock (SS) demand of 2,000 units for the safety stock requirement of 2,000 units. On April 8, there is a high priority planned order to fulfill the H demand of 1,000 units. On April 15, the safety stock drops 1,000 units (from 2,000 to 1,000, according to the safety stock schedule 502), allowing for 1,000 units as Safety Stock Supply (SSS) to be available for any demand on or after April 15. On April 15, there is a H demand of 1,000 units, which can be filled by the 1,000 units available from the drop. Therefore, there is no need for a planned order for the high priority demand of 1,000 units on April 15. On April 22, there is further drop in the safety stock supply of 1,000 units, as the safety stock level goes from 1,000 units to 0 units. These 1,000 units are available to fill the H demand of 1,000 units on April 22. Therefore, there is no need for a planned order for the H demand of 1,000 units on April 22. The planned order schedule 506 thus include two planned orders: one SS priority PO of 2,000 units on April 1 (for the safety stock of A) and one high priority PO of 1,000 units on April 8.

Receiver 406 has a real demand schedule 508 and planned order schedule 510. In this scenario, receiver 406 has no safety stock schedule, and therefore, no safety stock demands. The real demand schedule 508 indicates a medium priority (M) demand of 500 units on April 15 and medium priority (M) demand for 500 units on April 22.

The planned order schedule 510 is then derived from the real demand schedule 508 quite straightforwardly since there is no safety stock supply. The planned order schedule 510 thus include two planned orders: one medium priority (M) PO of 500 units on April 15 (to fill the M demand of 500 units on April 15) and one medium priority (M) PO of 500 units on April 22 (to fill the M demand of 500 units on April 22).

The real demand schedule 512 of supplier 402 is derived from the planned order schedule 506 of receiver 404 and the planned order schedule 510 of receiver 406. Therefore, real demand schedule 512 includes a L demand of 2,000 units on April 1 (for safety stock of receiver 404); a H demand of 1,000 units on April 8 (based on the H planned order of 1,000 units on April 8 for receiver 404); a M demand of 500 units on April 15 (based on the M planned order of 500 units for receiver 406); and a M demand of 500 units on April 22 (based on the M planned order of 500 units for receiver 406). Since supplier 402 is providing the units for each of receiver 404 and receiver 406, it has a manufacturing schedule 514 to manufacture units required by each receiver. In this embodiment, manufacturing schedule 514 is set at the production of 1,000 units every week, for four weeks, beginning on April 8.

FIG. 6 illustrates a production result based on demand scheduling of FIG. 5. The manufacturing schedule 514 of supplier 402 will fulfill the real demand schedule 512 of supplier 402. As such, 1,000 units manufactured by supplier 402 on April 8 fulfill the H demand order (by supplier 402) of 1,000 units. This demand originates from the H demand of 1,000 units on April 8 by receiver 404. This demand is fulfilled successfully on time as shown by arrow 602.

Similarly, the 500 units manufactured by supplier 402 on April 15 fulfill the M demand order (by supplier 402) of 500 units on April 15. This demand originates from the M demand of 500 units on April 15 by receiver 406. This demand is fulfilled successfully on time as shown by arrow 604.

Finally, the 500 units manufactured by supplier 402 on April 22 fulfill the M demand order (by supplier 402) of 500 units on April 22. This demand originates from the MP demand of 500 units on April 22 by receiver 406. This demand is fulfilled successfully on time as shown by arrow 606.

Note however, that real demand schedule 512 and manufacturing schedule 514 of supplier 402 fail to fulfill the receiver 404 H demand of 1,000 units on April 15 and the receiver 404 H demand of 1,000 units on April 22. The medium priority demands of receiver 406 are satisfied in a constrained condition ahead of two high priority demands of receiver 404. Two H demands by receiver 404 are late, which has negative consequences for receiver 404.

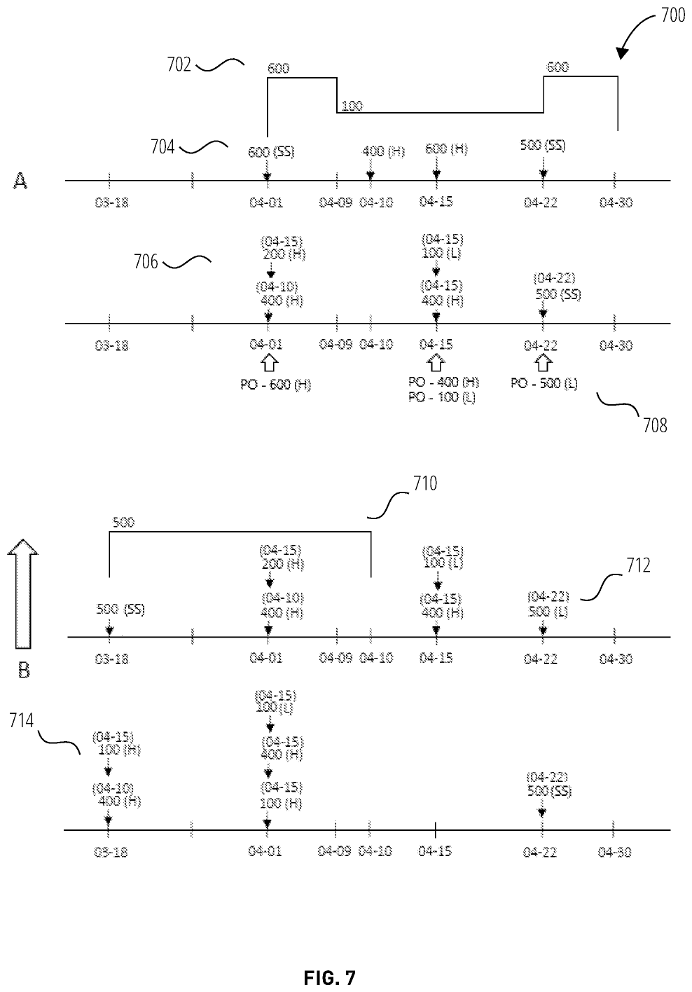

FIG. 7 illustrates a demand transformation in a supply chain 700 in accordance with one embodiment. The supply chain entity B feeds the supply chain entity A. In the embodiment of the demand transformation shown in FIG. 7, the transformed demand schedule of each supply chain entity is identical to the planned order of that entity.

The safety stock schedule of A 702 and the full demand schedule of A 704 are identical with those of the conventional example shown in FIG. 3. However, after application of an embodiment of a demand transformation, the resulting transformed demand schedule of A 706 is different from that of the full demand schedule of A 306 in FIG. 3. Furthermore, the planned order of A 708 is not identical to the planned order schedule of A 308 in FIG. 3. Whereas the planned order schedule of A 308 includes two low priority orders (600 units on April 1 and 500 units on April 22) and one high priority order (500 units on April 15), the planned order of A 708 following application of an embodiment of the demand transformation includes two high priority planning orders: April 1 for 600 units (consisting of a 400-unit order and a 200-unit order) an April 15 for 400 units; and two low priority orders: April 15 for 100 units and April 22 for 500 units. The only common planning order between planned order schedule of A 308 and planned order of A 708 is the April 22 low priority planning order of 500 units.

The safety stock schedule of B 710 is identical with the safety stock schedule of B 310 in FIG. 3. However, the full demand schedule of B 712 (which is identical to the transformed demand schedule of A 706) is different from the full demand schedule of B 314 of FIG. 3. Furthermore, the transformed demand schedule of B 714 is identical to the planned order schedule of B—whereas in FIG. 3, the full demand schedule of B 314 is not identical to the planned order schedule of B 316.

In FIG. 7, the planned order schedule of B includes orders on March 18, April 1 and April 22. On March 18, there is a H order for 400 units for April 10 and a H order of 100 units for April 15. On April 1, there is a L order of 100 units for April 15; a H order of 400 units for April 15; and a H order of 100 units for April 15. On April 22, there is a L order of 500 units for April 22. After applying the demand transformation to the demand schedules of A and B, the planned order of B includes four H orders and two L orders. Compare this with the conventional approach shown in FIG. 3, in which the planned order of B consists only of two L orders.

The exemplary demand transformation shown in FIG. 7 can be obtained using flowchart 800, which is described below.

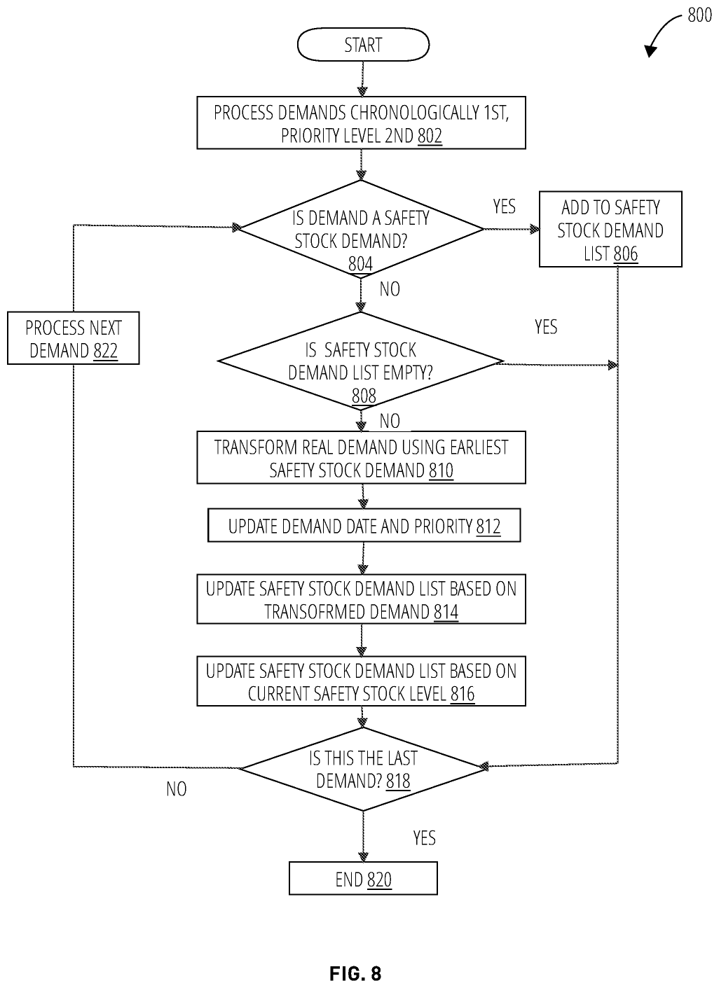

FIG. 8 is a flowchart 800 for demand transformation in accordance with one embodiment. The transformation begins at step 802, where the demands of a supply chain entity are processed first in chronological order. If there are two or more demands having the same demand date, then process the demands according to priority level, from highest to lowest. Recall that the order of priority, from lowest to highest, is as follows: safety stock (SS) demand<low priority (L) real demand<medium priority (M) real demand<high priority real (H) demand.

If the demand is a safety stock demand (step 804), then the demand is added to a safety stock demand list at step 806. Each entry in the safety stock demand list includes the date and quantity of the safety stock demand. After step 806, the method checks to see if this is the last demand at step 818. If it is, the program ends (step 820). If not, the method proceeds to the next demand at step 822 and reverts to step 802 to begin processing the next demand.

If, on the other hand, the demand is not a safety stock demand (i.e. it is a real demand), then the method looks to the safety stock demand list at step 808. If the list is empty, then the method checks to see if this real demand is the last demand (step 818). If it is, the program ends (step 820). If not, the method proceeds to process the next demand at step 822 and begins the process of analyzing the type of demand at step 804.

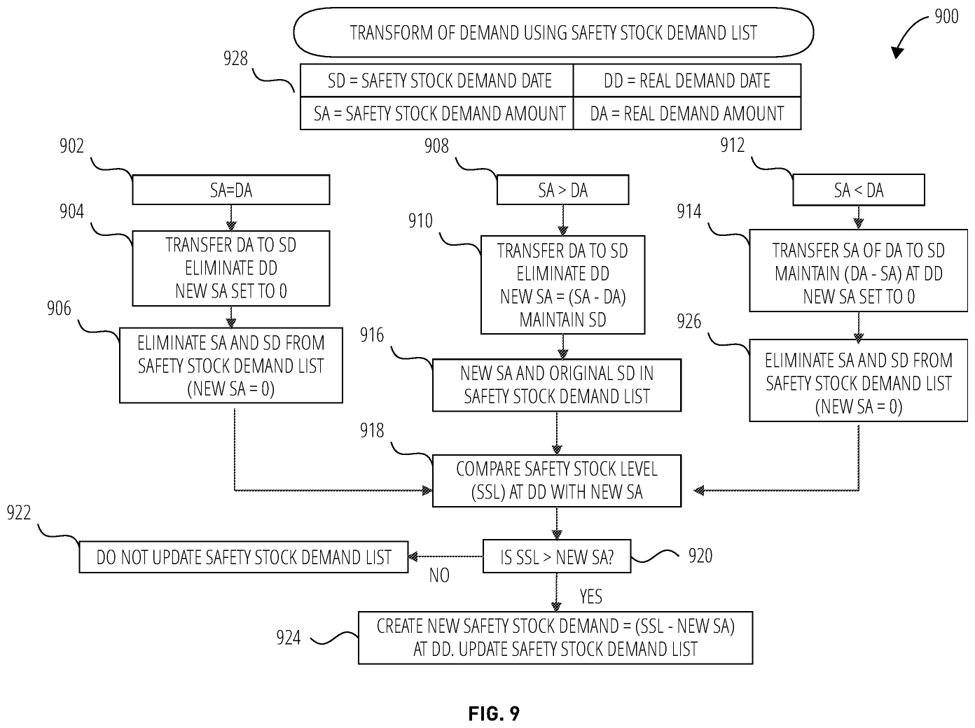

If the safety stock demand list is not empty, then the demand is transformed using the earliest safety stock demand in the list at step 810. Details of the transformation are described in FIG. 9. The date and priority of the transformed demand are updated at step 812 (which is further described in FIG. 9). The safety stock demand list is then updated based on the demand transformation at step 814 - which is further described in FIG. 9. The safety stock list is further updated based on the current safety stock level at step 816—which is further described in FIG. 9. If there are no more demands, then the process ends (step 820); otherwise it proceeds to the next demand at step 822 and begins the process of analyzing the type of demand at step 804.

FIG. 9 illustrates a demand transformation using safety stock demand list in accordance with one embodiment. Step 810, step 812, step 814 and step 814 of FIG. 8, are further elaborated in FIG. 9. Definitions 928 are described below.

Definitions 928 are as follows: a real demand has a real demand amount (DA) at a real demand date (DD). At step 810, the earliest safety stock demand (in the safety stock demand list) has a safety stock demand amount (SA) at a safety stock demand date (SD). The next steps depend on the relationship between the safety stock amount (SA) and the real demand amount (DA).

Where SA=DA (at block 902), the transformation of the real demand using the earliest safety stock demand is described at block 904. The demand amount (DA) is completely transferred to the safety stock demand date (SD). The real demand date (DD) is eliminated and the new safety stock demand amount is set to zero (since it is wholly transferred to DA). The safety stock demand list is updated at block 906 by eliminating the earliest safety stock demand in the safety stock demand list. That is, the new safety stock demand amount (New SA) (in the safety stock demand list) is zero. The safety stock demand list is then further updated by comparing the new safety stock demand amount (new SA) with the safety stock level (SSL) at the real demand date (DD) at block 918 and block 920. If the safety stock level (SSL) is greater than what is in the updated safety stock demand list, then a new safety stock demand must be created for an amount equal to (SSL-NEW SA) at the real demand date (DD) at block 924. The safety stock demand list is then updated at block 924 to reflect the new safety stock demand. If the safety stock level (SSA) is not less than the new safety stock demand amount (new SA) on the real demand date (DD), then the safety stock demand list is not updated (since no new safety stock demand has been created).

Where SA>DA (at block 908), the transformation of the real demand using the earliest safety stock demand is described at block 910. The real demand amount (DA) is completely transferred to the safety stock demand date (SD). The real demand date (DD) is eliminated and the new safety stock demand amount (new SA) is set to (SA-DA), since it is partly transferred to DA. The safety stock demand list is updated at block 916 by replacing the safety stock demand amount (SA) with the new safety stock demand amount (New SA) at the safety stock demand date (SD). The safety stock demand list is then further updated at steps 718-724, as described above.

Where SA<DA (at block 912), the transformation of the real demand using the earliest safety stock demand is described at block 914. A partial demand amount equal to the safety stock demand amount (SA) is transferred to the safety stock demand date (SD). The safety stock demand amount is thus set to zero. The remaining portion of the real demand amount (equal to DA-SA) is maintained at the real demand date (DD). At block 926, since the safety stock demand amount has been completely used, it is eliminated from the safety stock demand list. The safety stock demand list is then further updated at steps 718-724, as described above.

### EXAMPLE 1

The flowcharts of FIG. 8 and FIG. 9 are applied to the safety stock schedule of A 702 and the full demand schedule of A 704 in FIG. 7, in order to arrive at the transformed demand schedule of A 706. These steps are described in detail as follows.

The initial full demand schedule of A 704 is as follows:
April 1: safety stock (SS) demand of 600 units (in order to maintain the required safety stock level of 600 units beginning April 1, as shown in the safety stock schedule of A 702.
April 10: HP real demand of 400 units
April 15: HP real demand of 600 units
April 22: safety (SS) safety stock demand of 500 units (in order to jump to the required safety stock level of 600 units from 100 units beginning April 22, as shown in the safety stock schedule of A 702).

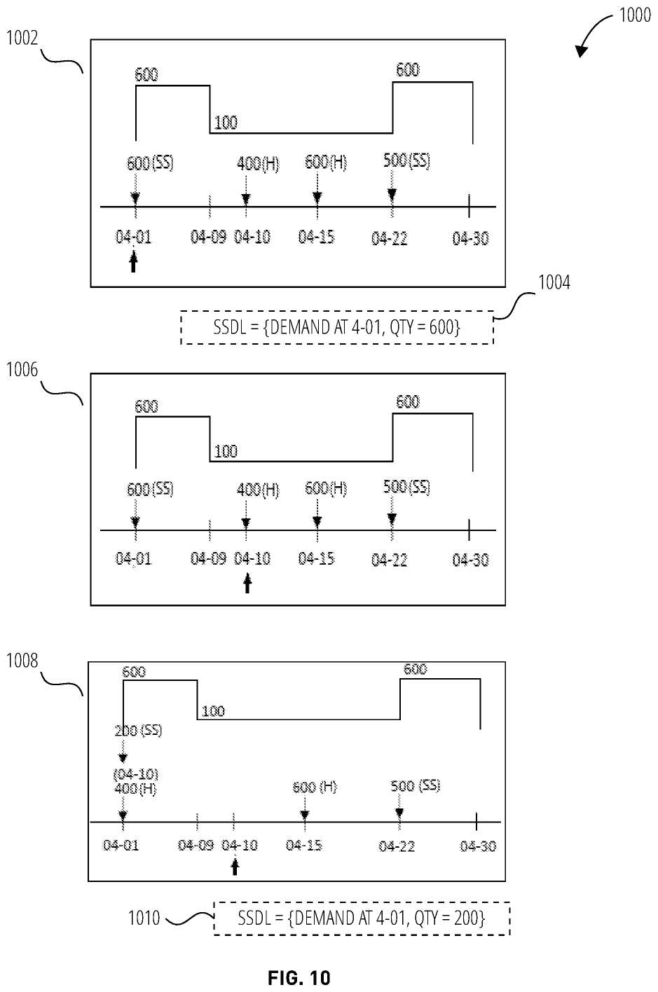

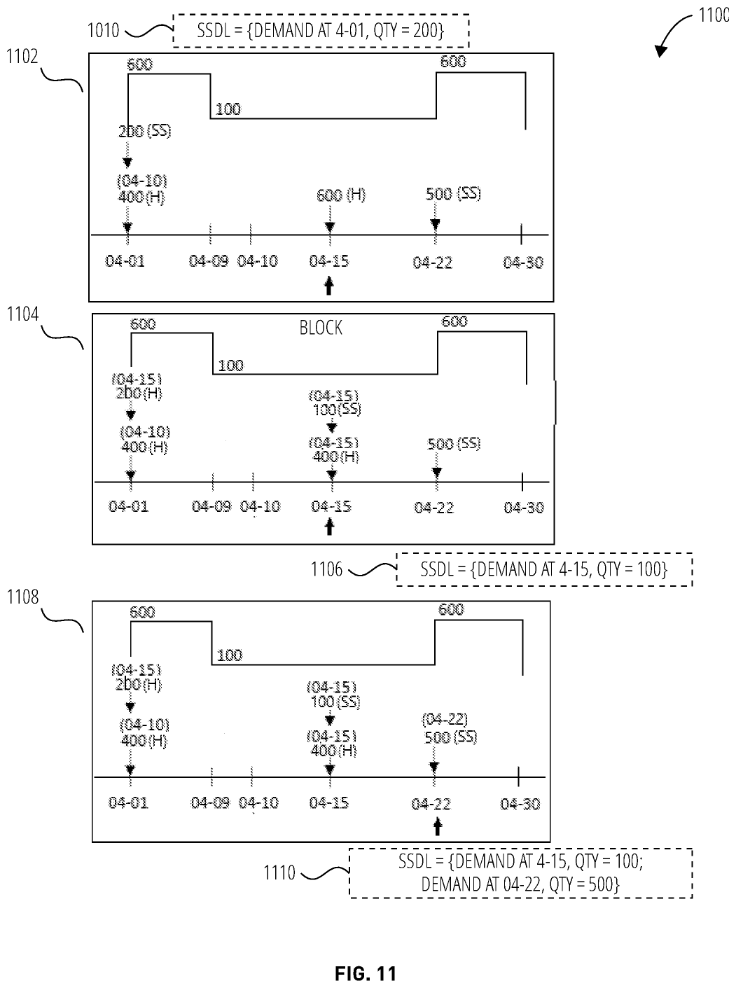

The above demands are processed according to the flowcharts shown FIG. 8 and FIG. 9 and elaborated in FIG. 10 and FIG. 11.

FIG. 10 illustrates demand processing of April 1 and April 10 of demands of A shown in FIG. 7.

The first demand is on April 1. Block 1002 indicates a safety stock demand in an amount of 600 units (LP). According to FIG. 8, the April 1 demand is processed as follows:
Is it a safety stock demand? (step 804)
Ans: Yes
Add to safety stock demand list (SSDL) (step 806)
Safety Stock List (SSDL)={demand at 04-01, Qty=600}
Is this the last demand? (step 818)
Ans: No
Go to next demand date (step 822)
Process next demand (step 802)

The safety stock demand list 1004 indicates one safety stock demand on April 1 for 600 units, which will be used when processing the next demand.

The next demand is on April 10. Block 1006 indicates a real demand in an amount of 400 units (HP). According to FIG. 8, the April 10 demand is processed as follows:
Is it a safety stock demand? (step 804)
Ans: No
Is safety stock demand list empty? (step 808)
Ans: No
Transform real demand using earliest safety stock demand (step 810)
Update demand date and priority (step 812)
Update safety stock demand list based on transformed real demand (step 814)

Update safety stock demand list based on current safety stock level (step 816)

The last four steps are performed according to FIG. 9:
SA=600; SD=04-01; DA=400; DD-04-10 (Definitions 928)
SA>DA (block 908)
Transfer DA=400 units to SD (April 1); New SA=(600-400)=200 units on April 1 (block 910)
Update Safety Stock List (SSDL)={demand at 04-01, Qty=200}
Safety stock level (SSL) on current demand date (April 10)=100; new safety stock demand amount (New SA)=200 (block 918).
SSL<New SA (block 920)
Do not update safety stock demand list (SSDL) (block 922)

The result is shown in block 1008, where there are now two demands on April 1: a real (H) demand of 400 units and a safety stock (SS) demand of 200 units. The updated safety stock demand list (SSDL) 1010 indicates a safety stock demand of 200 units on April 1.

FIG. 11 illustrates demand processing of April 15 and April 22 of demands of A shown in FIG. 7.

The next demand is on April 15. Block 1102 indicates a real H demand in an amount of 600 units, According to FIG. 8, the April 15 demand is processed as follows:
Is it a safety stock demand? (step 804)
Ans: No
Is safety stock demand list empty? (step 808)
Ans: No
Transform real demand using earliest safety stock demand (step 810)
Update demand date and priority (step 812)
Update safety stock demand list based on transformed demand (step 814)
Update safety stock demand list based on current safety stock level (step 816)

The last four steps are performed according to FIG. 9:
SA=200; SD=04-01; DA=600; DD-04-15 (Definitions 928)
SA<DA (block 912)
Transfer SA=200 units of DA to SD (April 1). Maintain (400-200) units of DA on DD (April 15). Set New SA to zero on April 1.
Update Safety Stock List (SSDL)={empty}
Safety stock level (SSL) on demand date (April 15)=100; new safety stock demand amount (New SA)=0 (block 918).
SSL>New SA (block 920).
Create new safety stock demand=(SSL-New SA)=(100-0)=100 units on demand date (DD) of April 15. Since this is a safety stock demand, it has the lowest priority.

The result is shown in block 1104, where there are now two demands on April 15: a HP real demand of 400 units and a safety stock (SS) demand of 100 units. The updated safety stock demand list (SSDL) 1106 indicates a safety stock demand of 100 units on April 15.

The next demand is on April 22. Block 1104 indicates a safety stock (SS) demand in an amount of 500 units. According to FIG. 8, the April 22 demand is processed as follows:
Is it a safety stock demand? (step 804)
Ans: Yes
Add to safety stock demand list (SSDL) (step 806)
Safety Stock List (SSDL)={demand at 04-22, Qty=500}
SA=200; SD=04-01; DA=600; DD-04-15 (Definitions 928)
SA<DA (block 912)
Transfer SA=200 units of DA to SD (April 1). Maintain (400-200) units of DA on DD (April 15). Set New SA to zero on April 1.
Update Safety Stock List (SSDL)={empty}
Safety stock level (SSL) on demand date (April 15)=100; new safety stock demand amount (New SA)=0 (block 918).
SSL>New SA (block 920).
Create new safety stock demand=(SSL-New SA)=(100-0)=100 units on demand date (DD) of April 15. Since this is a safety stock demand, it has the lowest priority.
Is this the last demand? (step 818)
Ans: Yes
End processing of demands of entity A (step 820)

The result is shown in block 1108, where there is one demand on April 22: a safety stock (SS) demand of 100 units. The updated safety stock demand list (SSDL) 1110 indicates two safety stock demands: 100 units on April 15; and 500 units on April 22.

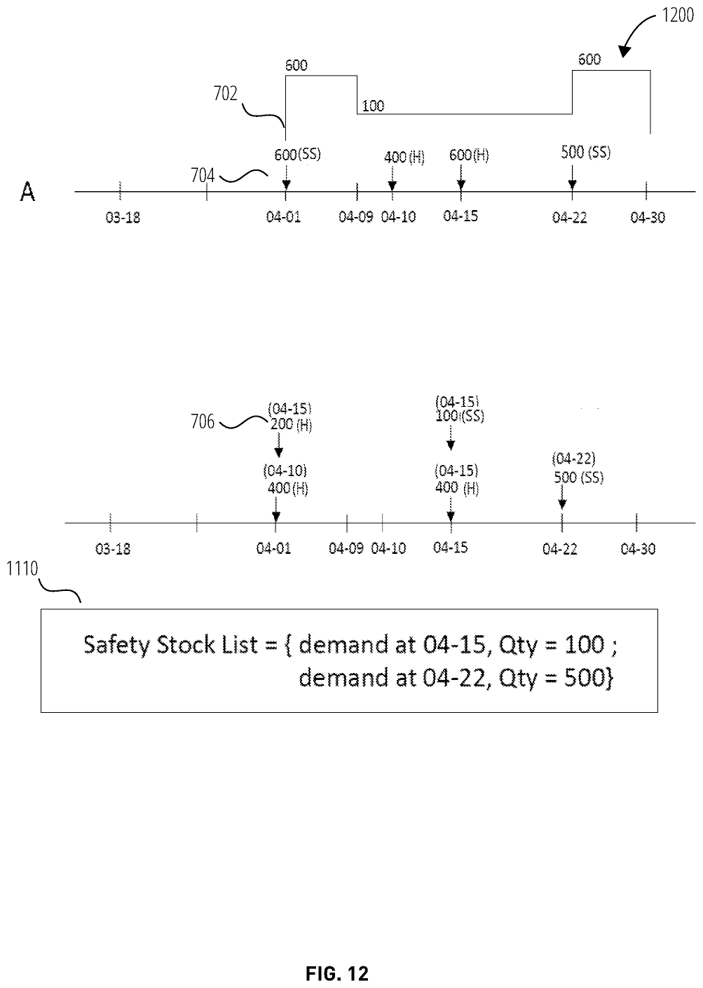

FIG. 12 illustrates transformation of demands of entity A in accordance with the embodiment shown in FIG. 7. As in FIG. 7, the initial safety stock schedule of A 702 and full demand schedule of A 704 are shown (prior to the demand transformation). Shown are the transformed demand schedule of A 706, along with the safety stock demand list (SSDL) 1106 of A, following the transformation.

### EXAMPLE 2

Turning to FIG. 7, the transformed demand schedule of A 706 is then downloaded as the full demand schedule of B 712. A safety stock (SS) demand on A are converted to low priority (L) real demand on B, since the safety stock demand (on A) is an external or “real” demand on B, but is of low priority.

By following the flowchart of FIG. 8 and FIG. 7, the transformed demand schedule of B 714 is obtained:
on March 18, two real demands: one for 400 H units for April 10, and one for 100 H units for April 15.
on April 1, a total of three demands: three real demands (100 H units for April 15, 400 H units for April 15. and 100 L units for April 15)
on April 22, one low priority (L) real demand of 500 units for April 22.

The above transformed demand results for supplier B are obtained as follows.

First demand is on March 18 for 500 units for a safety stock (SS) demand
Is it a safety stock demand? (step 804)
Ans: Yes
Add to safety stock demand list (SSDL) (step 806)

Process next demand date (step 802)

Safety Stock List (SSDL)={demand at 03-18, Qty=500}

Next chronological demand is on April 1 for 400 H units for a real demand for April 10
Is it a safety stock demand? (step 804)
Ans: No
Is safety stock demand list empty? (step 808)
Ans: No, Safety Stock List (SSDL)={demand at 03-18, Qty =500}
Transform real demand using earliest safety stock demand (step 810)
SA=500; SD=03-18; DA=400; DD-04-01(Definitions 928)
SA>DA (block 908)
Transfer DA=400 units to SD (March 18). New SA=(500-400) units on March 18 (block 910)
Real Demand of 400 H units (for April 10) is on March 18
Update Safety Stock List (SSDL)={demand at 03-18, Qty=100} (block 916)
Safety stock level (SSL) on current demand date (April 1)=500; new safety stock demand amount (New SA)=100 (block 918).
SSL>New SA (block 920).
Create new safety stock demand=(SSL-New SA)=(500-100)=400 safety stock units on demand date (DD) of April 1. (block 924).
Is this the last demand? (step 818)
Ans: No
Go to next demand date (step 822)

Safety Stock List (SSDL)={demand at 03-18, Qty=100; demand at 04-01, Qty=400}

Next chronological demand is on April 1 for 200 H units for a real demand for April 15.
Is it a safety stock demand? (step 804)
Ans: No
Is safety stock demand list empty? (step 808)
Ans: No, Safety Stock List (SSDL)={demand at 03-18, Qty=100; demand at 04-01, Qty=400}
Transform real demand using earliest safety stock demand (step 810)
Earliest safety stock demand is 100 units at 03-10
SA=100; SD=03-18; DA=200; DD-04-01 (Definitions 928)
SA<DA (block 912)
Transfer SA=100 units of DA=200 units to SD (March 18). Maintain (200-100) units of real demand on DD=April 1. New SA=0 units on March 18 (block 914).
Real Demand of 100 H units (for April 15) is on March 18
Real Demand of 100 H units (for April 15) is on April 1
Update Safety Stock List (SSDL)={demand at 04-01, Qty=400} (block 926)
Safety stock level (SSL) on current demand date (April 1)=500; new safety stock demand amount (New SA)=400 (block 918).
SSL>New SA (block 920).
Create new safety stock demand=(SSL-New SA)=(500-400)=100 safety stock units on demand date (DD) of April 1. (block 924).
Is this the last demand? (step 818)
Ans: No
Go to next demand date (step 822)
Safety Stock List (SSDL)={demand at 04-01, Qty=100; demand at 04-01, Qty=400}
Next chronological demand is on April 15. There are two real demands: 400 H units (for 04-15) and 100 L units (for 04-15).
Process 400 H units first (step 802).
Is it a safety stock demand? (step 804)
Ans: No
Is safety stock demand list empty? (step 808)
Ans: No, Safety Stock List (SSDL)={demand at 04-01, Qty=100; demand at 04-01, Qty=400}
Transform real demand using earliest safety stock demand (step 810) Both safety stock demands have same date. Use 400 safety stock demand.
SA=400; SD=04-01; DA=400; DD-04-15 (Definitions 928)
SA=DA (block 702)
Transfer DA=400 H units to SD (04-01). Eliminate DD=04-15. New SA=0 (block 914).
Real Demand of 400 H units (for April 15) is on April 1
Update Safety Stock List (SSDL)={demand at 04-01, Qty=100} (block 926)
Safety stock level (SSL) on current demand date (April 15)=0; new safety stock demand amount (New SA)=100 (block 918).
SSL<New SA (block 920).
Do not update safety stock demand list (block 922).
Is this the last demand? (step 818)
Ans: No
Go to next demand date (step 822)
Safety Stock List (SSDL) ={demand at 04-01, Qty =100}

Next, process real demand of 100 L units on April 15.
Is it a safety stock demand? (step 804)
Ans: No
Is safety stock demand list empty? (step 808)
Ans: No, Safety Stock List (SSDL)={demand at 04-01, Qty=100}
Transform real demand using earliest safety stock demand (step 810)
SA=100; SD=04-01; DA=100; DD-04-15; (Definitions 928)
SA=DA (block 902)
Transfer DA=100 L units to SD (04-01). Eliminate DD=04-15. New SA=0 (block 914).
Real Demand of 100 L units (for April 15) is on April 1
Update Safety Stock List (SSDL)={empty} (block 926)
Safety stock level (SSL) on current demand date (April 15)=0; new safety stock demand amount (New SA)=0 (block 918).
SSL<New SA (block 920).
Do not update safety stock demand list (block 922).
Is this the last demand? (step 818)
Ans: No
Go to next demand date (step 822)
Safety Stock List (SSDL)={empty}

Final demand is on April 22 for a real demand of 500 L units:
Is it a safety stock demand? (step 804)
Ans: No
Is safety stock demand list empty? (step 808)
Ans: yes

Real Demand of 100 L units (for April 22) is on April 22
Is this the last demand? (step 818)
Ans: yes
End (step 820)

From the above transformations, we see that the following transformed demands are obtained:

Real Demand of 400 H units (for April 10) is on March 18

Real Demand of 100 H units (for April 15) is on March 18

Real Demand of 100 H units (for April 15) is on April 1

Real Demand of 100 L units (for April 15) is on April 1

Real Demand of 100 LP units (for April 22) is on April 22

This matches the transformed demand schedule of B 714 shown in FIG. 7.

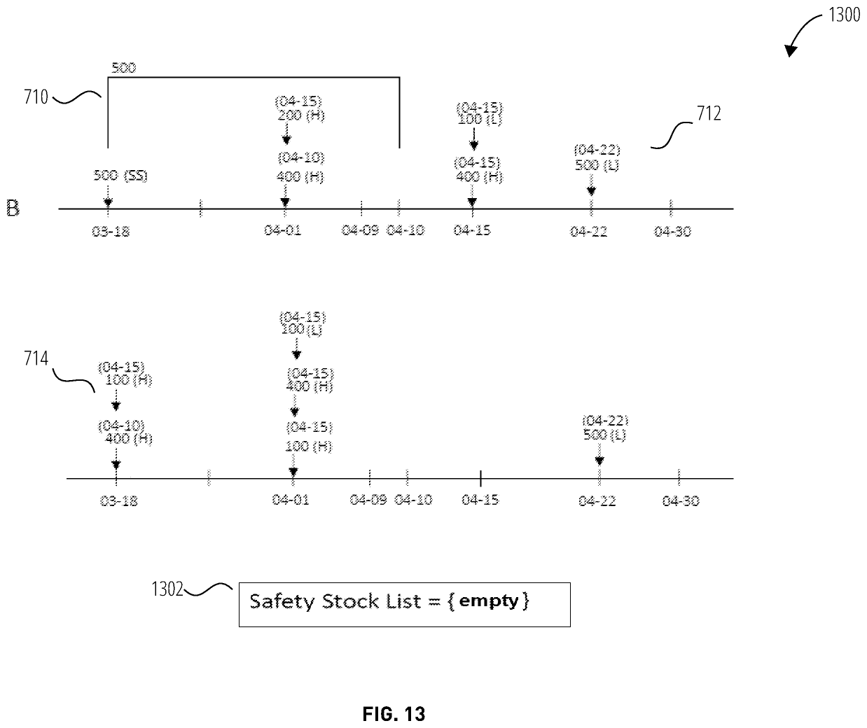

FIG. 13 illustrates transformation of demands of entity B in accordance with the embodiment shown in FIG. 7. As in FIG. 7, the initial safety stock schedule of B 710 and full demand schedule of B 712 are shown (prior to the demand transformation). The transformed demand schedule of B 714 is shown, along with the safety stock demand list (SSDL) 1302 of B. following the transformation. Note that there is no safety stock schedule for B, following the transformation.

illustrates a transformation of demand schedules in accordance with one embodiment. The examples of supplier 402, receiver 404 and receiver 406, shown in FIG. 4 and FIG. 5, are shown. The safety stock schedule 502 and real demand schedule 504 of receiver 404 are as in FIG. 5. The real demand schedule 508 of receiver 406 are as in FIG. 5. Finally, the manufacturing schedule 514 of supplier 402 are as in FIG. 5.

Once the demand transformation is applied to real demand schedule 504, the resulting transformed demand schedule 1404 of receiver 404 is obtained, in which there are the following three real demands:

On April 1, 1,000 (H) units for 04-08

On April 1, 1,000 (H) units for 04-15

On April 8, 1,000 (H) units for 04-22

Since receiver 406 has no safety stock schedule, the real demand schedule 508 remains unchanged.

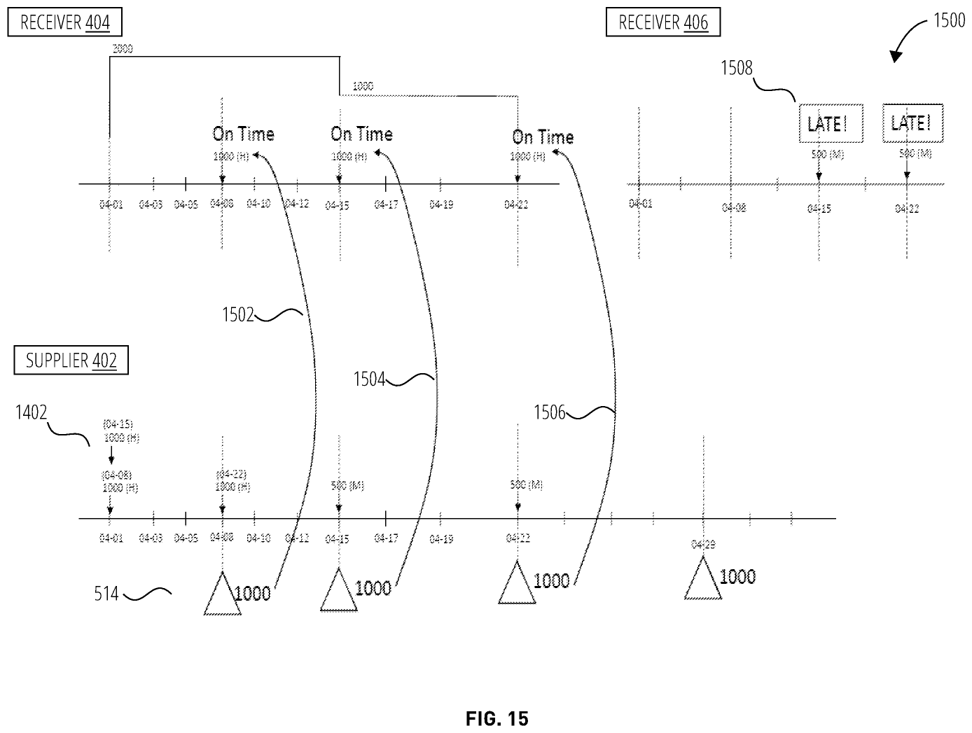

The transformed demand schedule 1404 and real demand schedule 508 are downloaded onto supplier 402. Since supplier 402 has no safety stock schedule, the downloaded schedule becomes the transformed demand schedule 1402 of supplier 402. The implications of transformed demand schedule 1402 of supplier 402 on the supply chain management schedule are shown in FIG. 15.

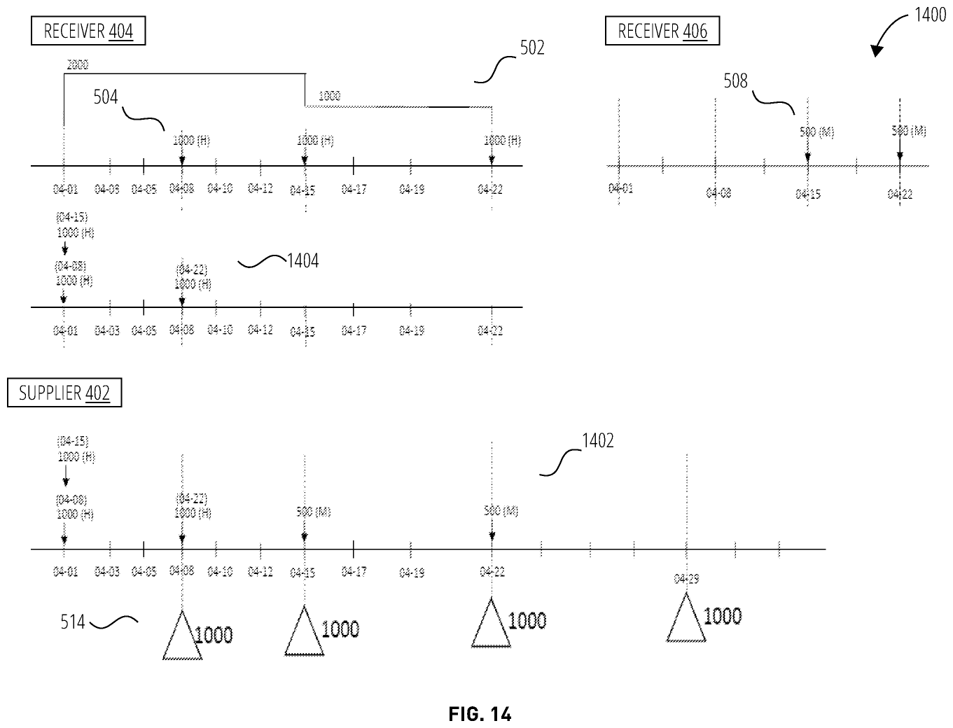

FIG. 15 illustrates a production result 1500 based on the transformed demand schedule 1404 of the receiver 404 and the transformed demand schedule 1402 of supplier 402 shown in FIG. 14.

Looking to manufacturing schedule 514 and transformed demand schedule 1402 of supplier 402, the first 1,000 units produced on April 8 will fill the first transformed demand on April 1—namely the real (H) demand for 1,000 units for April 8. That is, the 1,000 (H) real demand on April 8 by receiver 404, is filled on time, as indicated by arrow 1502.

Continuing with the manufacturing schedule 514 and the transformed demand schedule 1402 of supplier 402, the next 1,000 units are produced on April 15. These will fill the next real demand order of April 1—namely 1,000 (H) units for April 15. That is, the 1,000 (H) real demand on April 15 by receiver 404, is filled on time, as indicated by arrow 1504.

Continuing with the manufacturing schedule 514 and the transformed demand schedule 1402 of supplier 402, the next 1,000 units are produced on April 22. These will fill the next real demand order of April 8—namely 1,000 (H) units for April 22. That is, the 1,000 (H) real demand on April 22 by receiver 404, is filled on time, as indicated by arrow 1506.

Continuing with the manufacturing schedule 514 and the transformed demand schedule 1402 of supplier 402, the next 1,000 units are produced on April 29. These will fill the next real demand order of April 15—namely 500 (M) units for April 15. However, this order is filled late, as indicated by 1508. The same holds true for the April 22 demand for 500 (M) units, which will be filled late.

However, the situation in FIG. 15 is much better compared with FIG. 6, in which no demand transformation is used. In FIG. 6, conventional demand planning results in only one H demand of receiver 404 being filled on time (i.e. April 8 for 1,000 H units), while the remaining two H demands required by receiver 404 (for 1,000 units on April 15 and 1,000 unites on April 22) are late.

When the demand transformation is used, as shown in the embodiment of FIG. 15, all three H demands of receiver 404 are filled on time.

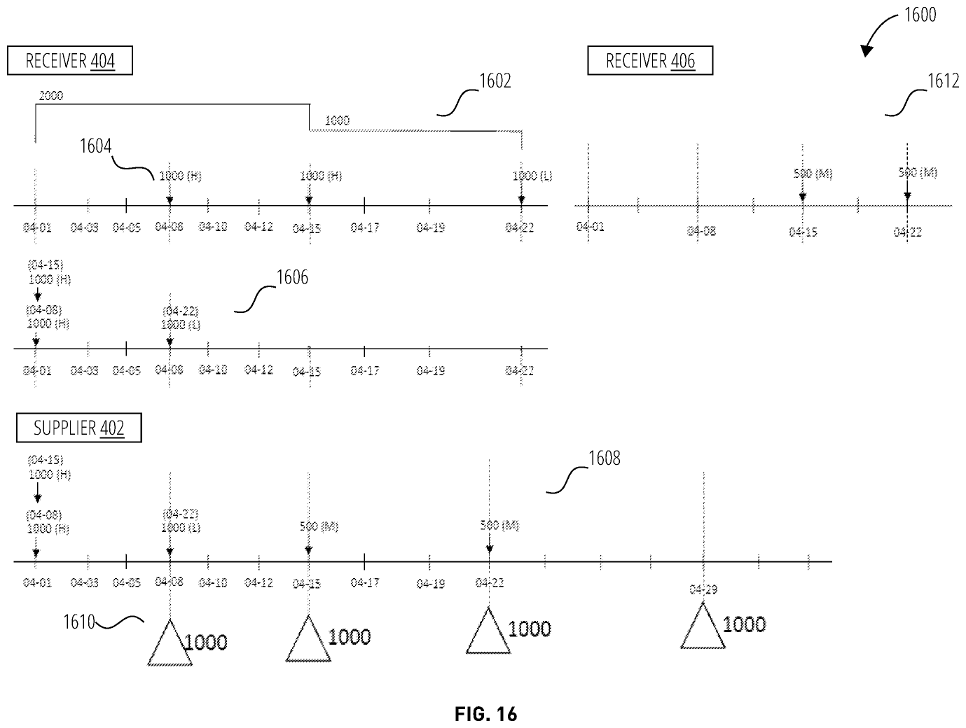

FIG. 16 illustrates a transformation of demand schedules 1600.

As in FIG. 4, there is supplier 402, a receiver 404 and a receiver 406. The safety stock schedule 1602 and real demand schedule 1604 of receiver 404, as shown in FIG. 16, are as follows:

Safety stock of 2000 units from April 1 to April 14; 1000 units from April 15 to April 21; and 0 units on April 22

High priority (H) real demand on April 8

High priority (H) real demand on April 15

Low priority (L) real demand on April 22

There is no safety stock for receiver 406 The real demand schedule 1612 of receiver 406, shown in FIG. 16, is as follows:

Medium priority (M) real demand on April 15

Medium priority (M) real demand on April 22

The manufacturing schedule 1610 of supplier 402 is as follows:

1000 units produced weekly on April 8, April 15, April 22 and April 29

Once the demand transformation is applied to real demand schedule 1604, the resulting transformed demand schedule 1606 of receiver 404 is obtained, in which there are the following three real demands:

On April 1, 1,000 (H) units for 04-08

On April 1, 1,000 (H) units for 04-15

On April 8, 1,000 (L) units for 04-22

Since receiver 406 has no safety stock schedule, the real demand schedule 1612 remains unchanged.

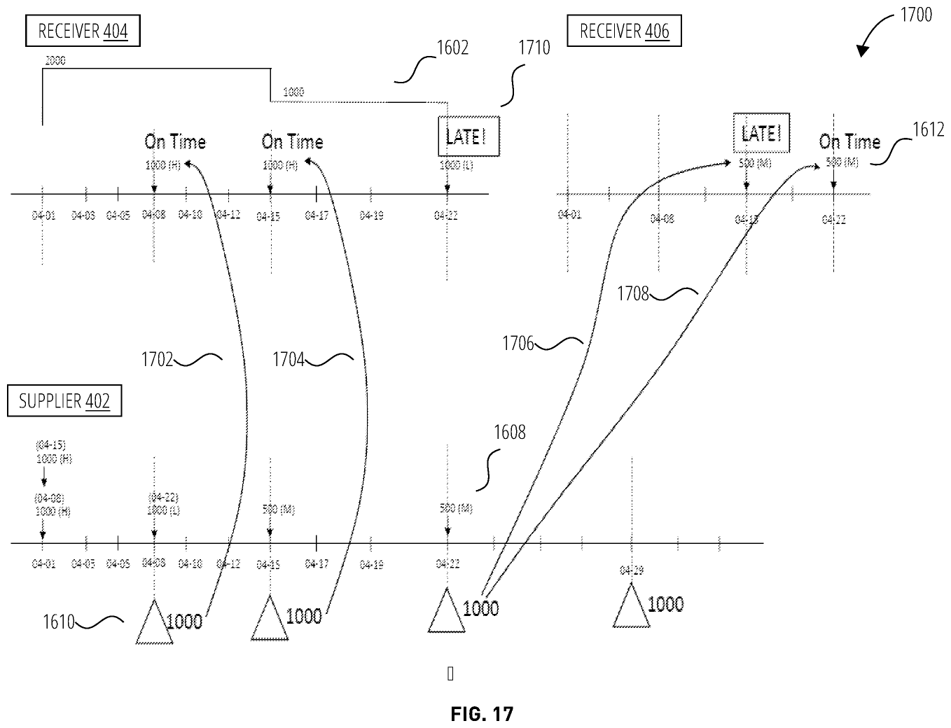

The transformed demand schedule 1606 and real demand schedule 1612 are downloaded onto supplier 402. Since supplier 402 has no safety stock schedule, the downloaded schedule becomes the transformed demand schedule 1608 of supplier 402. The implications of transformed demand schedule 1608 of supplier 402 on the supply chain management schedule are shown in FIG. 17.

FIG. 17 illustrates a production result 1700 based on the real demand schedule 1604 of the receiver 404, the real demand schedule 1612 of receiver 406 and the transformed demand schedule 1608 of supplier 402 shown in FIG. 16.

Looking to manufacturing schedule 1610 and transformed demand schedule 1608 of supplier 402, the first 1,000 units produced on April 8 will fill the first transformed demand on April 1—namely the real (H) demand for 1,000 units for April 8. That is, the 1,000 (H) real demand on April 8 by receiver 404, is filled on time, as indicated by arrow 1702.

Continuing with the manufacturing schedule 1610 and the transformed demand schedule 1608 of supplier 402, the next 1,000 units are produced on April 15. These will fill the next real demand order of April 1—namely 1,000 (H) units for April 15. That is, the 1,000 (H) real demand on April 15 by receiver 404, is filled on time, as indicated by arrow 1704.

Continuing with the transformed demand schedule 1608 and the manufacturing schedule 1610 of supplier 402, the next 1,000 units are produced on April 22. These will fill the next two real demand medium priority orders of 500 units each. Supplier 402 fills orders in order of demand priority—not chronological order. This is why the April 15 and April 22 real demands of 500 medium priority (M) units are filled before the April 8 real demand of low priority (L) units. However, the April 15 real (M) demand of 500 units is filled late, as indicated by arrow 1706, whereas the April 22 real (M) demand of 500 units is on time (as indicated by arrow 1708).

Continuing with the transformed demand schedule 1608 and the manufacturing schedule 1610 of supplier 402, the next 1,000 units are produced on April 29. These will fill the next real demand order of April 8—namely 100 (L) units for April 22. However, this order is filled late, as indicated by 1710.

However, compared with FIG. 6, in which conventional demand planning results in only one H demand of receiver 404 being filled on time (i.e. April 8 for 1000 HP units).

Although the algorithms described above including those with reference to the foregoing flow charts have been described separately, it should be understood that any two or more of the algorithms disclosed herein can be combined in any combination. Any of the methods, modules, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an application specific integrated circuit (ASIC), a programmable logic device (PLD), a field programmable logic device (FPLD), discrete logic, etc.). Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner and can be used separately or in combination.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A system for optimizing inventory in a supply chain, the supply chain comprising a plurality of entities, each entity having a full demand schedule, each entity being either a supplier, a node or a customer; the system comprising:
one or more processors; and
a memory storing instructions that, when executed by the one or more processors, configure the system to:
starting at each customer, create, by an optimization engine, a transformed demand planning schedule from a full customer demand schedule that is downloaded to an upstream entity linked to the respective customer in the supply chain;
at each upstream entity, create, by the optimization engine a transformed demand planning schedule that is downloaded to one or more successive upstream entities, ending at each supplier;
wherein creating a transformed demand planning schedule at each entity comprises:
accessing, by a supply chain planning engine, a full demand schedule of a supply chain entity, the full demand schedule comprising a safety stock schedule and a demand planning schedule;
processing chronologically, by the one or more processors, a demand of the full demand schedule, the demand being either a safety stock demand or a real demand;
processing, by the one or more processors, two or more demands according to level of priority, from highest priority to lowest priority, when the two or more demands have an identical demand date; and
creating, by an optimization engine, a transformed demand planning schedule by allocating one or more safety stock demands to one or more real demands and creating one or more new safety stock demands to maintain the safety stock schedule.

2. The system of claim 1, wherein the memory storing instructions that, when executed by the one or more processors, further configure the system to:
where the demand is a safety stock demand: add, by the optimization engine, a safety stock date of the safety stock demand and a safety stock quantity of the safety stock demand to a safety stock demand list; and
where the demand is a real demand and the safety stock demand list is not empty: transform, by the optimization engine, the real demand, or a portion thereof, to an earliest demand in the safety stock demand list; and update the safety stock demand list to include an updated safety stock demand that maintains a safety stock quantity on the date of the earliest demand.

3. The system of claim 2, wherein where the demand is a real demand, the memory storing instructions that, when executed by the one or more processors, further configure the system to:
where a real demand quantity of the demand is less than or equal to a safety stock quantity of the earliest demand in the safety stock demand list:
i) move, by the optimization engine, the real demand to the earliest demand date in the safety stock demand list; and
ii) subtract, by the optimization engine, the non safety real demand quantity from a safety stock quantity of the earliest demand in the safety stock demand list, to provide the updated safety stock demand on the date of the earliest demand.

4. The system of claim 3, wherein the memory storing instructions that, when executed by the one or more processors, further configure the system to:
compare, by the optimization engine, the updated safety stock demand with a safety stock level on the demand date; and
create, by the optimization engine, a new safety stock demand on the demand date in the safety stock demand list, if the safety stock level is greater than the updated safety stock demand.

5. The system of claim 1, wherein creating, by the optimization engine, the transformed demand planning schedule, comprises:
if the demand is a safety stock demand:
adding, by the optimization engine, the demand to a safety stock demand list;
if the demand is a real demand and the safety stock demand list is not empty:
transforming, by the optimization engine, the real demand into a transformed demand using an earliest safety stock demand in the safety stock demand list;
updating, by the optimization engine, a demand date of the transformed demand and a demand priority of the transformed demand;
updating, by the optimization engine, the safety stock demand list based on the transformed demand; and
updating, by the optimization engine, the safety stock demand list based on a current safety stock level.

6. A method for optimizing inventory in a supply chain, the supply chain comprising a plurality of entities, each entity having a full demand schedule, each entity being either a supplier, a node or a customer; the method comprising:
starting at each customer, create a transformed demand planning schedule from a full customer demand schedule that is downloaded to an upstream entity linked to the respective customer in the supply chain;
at each upstream entity, create a transformed demand planning schedule from a full upstream entity demand schedule that is downloaded successively upstream until a supplier is reached;
wherein creating a transformed demand planning schedule comprises:
accessing, by a supply chain planning engine, a full demand schedule of a supply chain entity, the full demand schedule comprising a safety stock schedule and a demand planning schedule;
processing chronologically, by one or more processors of a server, a demand of the full demand schedule, the demand being either a safety stock demand or a real demand;
processing, by the one or more processors, two or more demands according to level of priority, from highest priority to lowest priority, when the two or more demands have an identical demand date; and
creating, by an optimization engine, a transformed demand planning schedule by allocating one or more safety stock demands to one or more real demands and creating one or more new safety stock demands to maintain the safety stock schedule.

7. The method of claim 6, further comprising:
determining, by the optimization engine, whether the demand is a safety stock demand or a real demand;
where the demand is a safety stock demand: adding, by the optimization engine, a safety stock date of the safety stock demand, and a safety stock quantity of the safety stock demand to a safety stock demand list; and
where the demand is a real demand and the safety stock demand list is not empty: transforming, by the optimization engine, the real demand or a portion thereof, to an earliest demand in the safety stock demand list and updating the safety stock demand list to include an updated safety stock demand list to include an updated safety stock demand on the date of the earliest demand.

8. The method of claim 7, wherein where the demand is a real demand, the method further comprising:
where the real demand quantity of the demand is less than or equal to a safety stock quantity of the earliest demand in the safety stock demand list:
i) moving, by the optimization engine, the real demand to the earliest demand date in the safety stock demand list; and
ii) subtracting, by the optimization engine, the non safety real demand quantity from a safety stock quantity of the earliest demand
in the safety stock demand list, to provide the updated safety stock demand on the date of the earliest demand.

9. The method of claim 8, further comprising:
comparing, by the optimization engine, the updated safety stock demand with a safety stock level on the demand date; and
creating, by the optimization engine, a new safety stock demand on the demand date in the safety stock demand list, if the safety stock level is greater than the updated safety stock demand.

10. The method of claim 6, wherein creating, by the optimization engine, the transformed demand planning schedule, comprises:
if the demand is a safety stock demand:
adding, by the optimization engine, the demand to a safety stock demand list; and
if the demand is a real demand and the safety stock demand list is not empty:
transforming, by the optimization engine, the real demand into a transformed demand using an earliest safety stock demand in the safety stock demand list;
updating, by the optimization engine, a demand date of the transformed demand and a demand priority of the transformed demand;
updating, by the optimization engine, the safety stock demand list based on the transformed demand; and
updating, by the optimization engine, the safety stock demand list based on a current safety stock level.

11. A non-transitory computer-readable medium embodied with software for optimizing inventory in a supply chain, the supply chain comprising a plurality of entities, each entity having a full demand schedule, each entity being either a supplier, a node or a customer, the software when executed using one or more processors on a server, is configured to:
starting at each customer, create a transformed demand planning schedule from a full customer demand schedule that is downloaded to an upstream entity linked to the respective customer in the supply chain;
at each upstream entity, create a transformed demand planning schedule from a full upstream entity demand schedule that is downloaded successively upstream until a supplier is reached;
wherein creating a transformed demand planning schedule comprises:
accessing, by a supply chain planning engine, a full demand schedule of a supply chain entity, the full demand schedule comprising a safety stock schedule and a demand planning schedule;
processing chronologically, by the one or more processors, a demand of the full demand schedule, the demand being either a safety stock demand or a real demand;
processing, by the one or more processors, the two or more demands according to level of priority, from highest priority to lowest priority, when the two or more demands have an identical demand date;
creating, by an optimization engine, a transformed demand planning schedule by allocating one or more safety stock demands to one or more real demands and creating one or more new safety stock demands to maintain the safety stock schedule.

12. The non-transitory computer-readable medium of claim 11, including instructions that when executed by the computer, further cause the computer to:
where the demand is a safety stock demand: add, by the optimization engine, a safety stock date of the safety stock demand, and a safety stock quantity of the safety stock demand to a safety stock demand list; and
where the demand is a real demand and the safety stock demand list is not empty: transform, by the optimization engine, the real demand, or a portion thereof, to an earliest demand in the safety stock demand list and update the safety stock list to include an updated safety stock demand on the date of the earliest demand.

13. The non-transitory computer-readable medium of claim 12, wherein when the demand is a real demand, including instructions that when executed by the computer, further cause the computer to:
where a real demand quantity of the demand is less than or equal to a safety stock quantity of the earliest demand in the safety stock demand list:
i) move, by the optimization engine, the real demand to the earliest demand date in the safety stock demand list; and
ii) subtract, by the optimization engine, the real demand quantity from a safety stock quantity of the earliest demand in the safety stock demand list, to provide the updated safety stock demand on the date of the earliest demand.

14. The non-transitory computer-readable medium of claim 13, including instructions that when executed by the computer, further cause the computer to:
compare, by the optimization engine, the updated safety stock demand with a safety stock to level on the demand date; and
create, by the optimization engine, a new safety stock demand on the demand date in the safety stock demand list, if the safety stock level is greater than the updated safety stock demand.

15. The non-transitory computer-readable storage medium of claim 11, wherein creating, by the optimization engine, the transformed demand planning schedule, comprises:
if the demand is a safety stock demand:
adding, by the optimization engine, the demand to a safety stock demand list; and
if the demand is a real demand and the safety stock demand list is not empty:
transforming, by the optimization engine, the real demand into a transformed demand using an earliest safety stock demand in the safety stock demand list;
updating, by the optimization engine, a demand date of the transformed demand and a demand priority of the transformed demand;
updating, by the optimization engine, the safety stock demand list based on the transformed demand; and
updating, by the optimization engine, the safety stock demand list based on a current safety stock level.

16. The system of claim 2, wherein where the demand is a real demand, the memory storing instructions that, when executed by the one or more processors, further configure the system to:
where a real demand quantity of the demand is greater than a safety stock quantity of the earliest demand in the safety stock demand list:
i) move, by the optimization engine, a first portion of the real demand to the earliest demand date in the safety stock demand list;
ii) maintain, by the optimization engine, a second portion of the real demand on the demand date; and
ii) set the updated safety stock demand on the date of the earliest demand to zero.

17. The system of claim 16, wherein the memory storing instructions that, when executed by the one or more processors, further configure the system to:
compare, by the optimization engine, the updated safety stock demand with a safety stock level on the demand date; and
create, by the optimization engine, a new safety stock demand on the demand date in the safety stock demand list, if the safety stock level is greater than the updated safety stock demand.

18. The method of claim 7, wherein where the demand is a real demand,
where a real demand quantity of the demand is greater than a safety stock quantity of the earliest demand in the safety stock demand list, the method further comprises
i) moving, by the optimization engine, a first portion of the real demand to the earliest demand date in the safety stock demand list;
ii) maintaining, by the optimization engine, a second portion of the real demand on the demand date; and
ii) setting the updated safety stock demand on the date of the earliest demand to zero.

19. The method of claim 18, wherein the method further comprises:
comparing, by the optimization engine, the updated safety stock demand with a safety stock level on the demand date; and
creating, by the optimization engine, a new safety stock demand on the demand date in the safety stock demand list, if the safety stock level is greater than the updated safety stock demand.

20. The non-transitory computer-readable medium of claim 2, wherein where the demand is a real demand, including instructions that when executed by the computer, further cause the computer to:
wherein where the demand is a real demand,
where a real demand quantity of the demand is greater than a safety stock quantity of the earliest demand in the safety stock demand list,
i) move, by the optimization engine, a first portion of the real demand to the earliest demand date in the safety stock demand list;
ii) maintain, by the optimization engine, a second portion of the real demand on the demand date; and
ii) set the updated safety stock demand on the date of the earliest demand to zero.

21. The non-transitory computer-readable medium of claim 20, including instructions that when executed by the computer, further cause the computer to:
compare, by the optimization engine, the updated safety stock demand with a safety stock level on the demand date; and
create, by the optimization engine, a new safety stock demand on the demand date in the safety stock demand list, if the safety stock level is greater than the updated safety stock demand.
